(19) United States
(12) Patent Application Publication
(10) Pub. No.: US 2005/0111721 A1
(43) Pub. Date: May 26, 2005

(54) Workstation for computerized analysis in mammography and methods for use thereof

(76) Inventors: Philippe Nathan Bamberger, Jerusalem (IL); Nicolas J. Merlet, Jerusalem (IL); Gil David Guggenheim, Jerusalem (IL)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/722,307

(22) Filed: Nov. 25, 2003

(51) Int. Cl. G06K 9/00; G06K 9/36

(52) U.S. Cl. 382/132; 382/168; 382/276

(57) ABSTRACT

A method for determining if the digitized image of a scanned film mammogram represents a left or right breast. The method also determines if the projection therein represents a craniocaudal projection or mediolateral oblique projection. Additionally, the method allows for automatic ordering of a set of digitized images according to a pre-selected order. A method is also provided for determining if the digitized image of a scanned film mammogram represents an improperly flipped or rotated view, automatically correcting the problem. Additionally the present invention provides for easy restarting of a workstation when the processing and/or scanning systems crash or an examination fails.

### FIELD OF THE INVENTION

The present invention relates to a mammogram workstation and methods for using such a workstation.

### BACKGROUND OF THE INVENTION

Breast cancer is one of the most common types of cancer afflicting Western society. It is estimated that the spread of the disease has risen in the United States, from one in twenty women being afflicted in 1940, to one in eight in 1995. The American Cancer Society estimated that 183,000 new cases of breast cancer were reported during 1995. In the United States, some 46,000 women die from the disease per year. Today, it is accepted that the best way to detect breast cancer in its early stages is by annual mammography screening of women aged 40 and up.

Today, radiologists generally interpret mammograms visually, using a light box, and their analysis is largely subjective. Film masking is used to highlight additional detail. In many cases, the radiologist employs supplementary tools such as a magnifying glass and bright light sources to evaluate very dark regions. If the mammogram is not conclusive the radiologist must recall the patient for an additional mammogram using one or more of the following techniques:
1. adding a view with a different projection;
2. performing a magnification mammogram by changing the distance between the breast and the film;
3. locally compressing the breast in the area of suspected abnormality; The analysis, even after using the above techniques, still remains mainly subjective.

In order to aid radiologists in reducing the false negative rate in mammographic screening, computer systems using specialized software and/or specialized hardware have been developed. These systems, often called computer-aided detection systems, hereinafter often denoted as “CAD systems”, have been known for many years and have been reported extensively. As noted below, their use in evaluating mammograms has been discussed at length in both the patent and professional literature.

CAD systems are typically used as follows. A radiological technician or a radiologist takes a set of radiological film images of the patient following a predetermined protocol. A radiologist views the film images and reaches a preliminary diagnosis. The radiologist next views separate, second images that are generated by the CAD system after processing the scanned and digitized set of film images. Typically, suspected abnormalities detected by the CAD system through computer analysis of the digitized version of the respective radiological film images appear as marked locations on the second images. After a reexamination of the areas of the original film images that correspond to the positions of the suspected abnormalities displayed on the CAD system, the physician makes a final diagnosis and determines a course of further action.

FIG. 1 to which reference is now made shows a block diagram of a simplified prior art CAD system designated as 100. Radiological films 110 taken by a radiologist or technician are scanned into and digitized by a digitizer 114. The digitized image produced is then fed into a processor 142, which uses any of many known algorithms to detect suspected abnormalities on the mammogram. Typical algorithms used for detecting abnormalities on the mammogram can be found in many of the references cited below. The digitized image is displayed on display 134. The displayed image shows the abnormalities detected, a location marker typically marking each abnormality. The image can be manipulated through a keyboard or other input device. Using a keyboard 138, the user instructs the processor to send the displayed images to a printer 118 for printing. The printout of the displayed digitized images includes location markers indicating suspected abnormalities on the images.

Computer-aided detection (CAD) mammography systems, and algorithms for use therewith, have been discussed extensively in many issued patents. An overview of the field can be obtained by reviewing U.S. Pat. No. 5,729,620 (Wang); U.S. Pat. No. 5,815,591 (Roehrig et al); U.S. Pat. No. 5,828,774 (Wang); U.S. Pat. No. 5,854,851 (Bamberger et al); U.S. Pat. No. 5,970,164 (Bamberger et al); U.S. Pat. No. 6,075,879 (Roehrig et al); U.S. Pat. No. 6,198,838 (Roehrig et al); U.S. Pat. No. 6,266,435 (Wang); and U.S. Pat. No. 6,434,262 (Wang). These patents, including references cited therein, are hereby incorporated by reference in this specification as though fully set forth herein.

Generally, a radiologist reads and analyzes several sets of mammograms one after another, each set relating to a different patient. The radiological films of the patients are often commingled during the digitizing process, as are the printed reports generated by the printer. Significant time is required by the staff of a radiology department to sort and collate the films with their respective printouts for insertion into the patient's physical files. The commingling of film and printed reports allows for the possibility of misplacement, error or even loss. In addition, the separation of films and printed reports, and then their subsequent collation generally requires a large work area.

Because of the many films and film sets usually handled by a technician there are other opportunities for errors. These errors can include flipping of films and rotation of films as they are entered for scanning. Additionally, most CAD workstations require a pre-selected order for the films of a given patient. Because of the large number of patients and films handled, the films may often be entered out of order. A workstation and method for automatically recognizing when a film set is out of order and/or when films are inadvertently flipped or rotated is currently lacking. Such a workstation and method would reduce time for data entry and management and would automatically correct for errors. Additionally, a system that automatically indicates when scanning has failed and assists by not requiring reentry of previously entered data would be valuable. Similarly, a system that restarts smoothly after it crashes is needed.

Terminology

The term “pre-selected presentation scheme” relates to both of the following: 1. the standard orientation of individual film mammogram projections, such as those described in conjunction with FIGS. 4A-4D herein below; and 2. the position of the various left craniocaudal (L-CC), right craniocaudal (R-CC), left mediolateral oblique (L-MLO) and right mediolateral oblique (R-MLO) views when they are presented for “reading” by a radiologist on a display, in a printout or on a light box.

In the discussion herein, we have referred to mediolateral oblique (MLO) projections. These projections could be replaced by mediolateral and oblique projections without altering the methods and systems of the present invention.

### SUMMARY OF THE PRESENT INVENTION

It is an object of the present invention to provide a method for determining if a mammogram image has been inadvertently flipped or rotated and is not in the standard orientation.

It is a further object of the present invention to provide a method for determining if a mammogram image is that of a right or a left breast.

An additional object of the present invention is to provide a method for determining if the mammogram image is a craniocaudal or mediolateral oblique projection.

It is an object of the present invention to provide a method for presenting in a pre-selected position the digitized images derived from a set of film mammograms.

It is yet another object of the present invention to provide a system and method for restarting the system smoothly after a system crash.

An additional objective of the present invention is to provide a method for automatically indicating when a scanning has failed and does not require reentry of previously entered data.

There is thus provided in accordance with the present invention a first method for processing film mammograms. The method includes the steps of: scanning a set of film mammograms, thereby to obtain digitized images of the film mammograms; storing the digitized images in a memory; preparing the digitized images for display by performing an analysis of the images in order to determine if they are properly adapted for a pre-selected presentation scheme; and bringing any improperly adapted images into their proper presentation scheme before displaying the images.

In an embodiment of the first method of the present invention, the step of preparing includes the step of determining whether the digitized images are properly oriented. The digitized image may have been inadvertently flipped or rotated.

In yet another embodiment of the first method of the present invention, the step of preparing includes the step of determining appropriate parameters for properly positioning the digitized images. This includes the steps of determining whether a digitized image is an image of the left or right breast and whether a digitized image is a craniocaudal (CC) or mediolateral oblique (MLO) projection.

In another aspect of the present invention, a second method is provided for processing film mammograms. This second method includes the steps of: scanning a set of film mammograms, thereby to obtain digitized images of the film mammograms; storing the digitized images in a memory; determining, for each digitized image, if the image represents a left or right breast; preparing the digitized images for display by performing an analysis of the images in order to determine the projection of each digitized image; and using the determined breast side and projection of each image to display the digitized images according to a pre-selected position irrespective of the order in which the film mammograms were scanned.

In yet another aspect of the present invention, a third method is provided for processing film mammograms. This third method includes the steps of: scanning a set of film mammograms, thereby to obtain digitized images of the film mammograms; storing the digitized images in a memory; preparing the digitized images for display by performing an analysis of the images in order to determine if each image is in the standard orientation; and using the analysis of the image to display the digitized images in the standard orientation irrespective of the orientation in which the film mammograms were scanned.

In an embodiment of this third method, the step of preparing includes the step of determining if the image was scanned after being inadvertently flipped.

In yet another embodiment of this third method, the step of preparing further includes the steps of: providing a binarized digitized image; removing the regions of the breast and muscle tissue from the image; determining the distance between each of the binarized pixels in a selected corner of the digitized image having a value of “1” and the nearest pixel having a value of “0”, the corner selected being the corner where a patient identification label is likely to be located based on a previous determination of breast side and the standard position of a label in an image; choosing the maximum distance found in the step of determining the distance; and comparing the maximum distance to a predetermined threshold value thereby to determine whether the film was inadvertently flipped when scanned and whether there is a label in the corner selected. This embodiment may also include the step of correcting for the flipped image by correctively flipping the image in a direction opposite to the original improper flip or alternatively the step of correcting for the flipped image by flipping and additionally, if required, rotating the image.

In yet another embodiment of this third method, the step of preparing further includes the step of determining if the image was scanned after being inadvertently rotated.

In determining if inadvertent rotation has occurred the step of determining may further include the steps of: providing a binarized digitized image; removing the regions of the breast and muscle tissue from the image; removing a previously located label from the image; determining the size of the largest bright objects in the upper half of the image and the largest object in the lower half of the object; and comparing the size of the largest bright object in the lower half of the image and the largest bright object in the upper half of the image against a predetermined value, wherein when the object in the lower half exceeds the predetermined value and the object in the upper half does not, a tag is located in the lower half of the image establishing that the image has been rotated.

In another embodiment of this third method, the method may further include the step of correcting for the inadvertently rotated image by correctively rotating the image.

In accordance with the present invention, there is provided a fourth method for determining if film mammograms have been improperly flipped and rotated prior to feeding the film mammogram into a scanner for providing digitized images, the method including the steps of: providing a binarized digitized image; removing the regions of the breast and muscle tissue from the image; determining the distance between each of the binarized pixels in a selected corner of the digitized image having a value of “1” and the nearest pixel having a value of “0”, the corner selected being the corner where a patient identification label is likely to be located based on a previous determination of breast side and the standard position of a label in an image; choosing the maximum distance found in the step of determining the distance; comparing the maximum distance to a predetermined threshold value thereby to determine whether the film was inadvertently flipped when scanned and whether there is a label in the corner selected; removing the previously located label from the image; determining the size of the largest bright objects in the upper half of the image and the largest object in the lower half of the object; and comparing the size of the largest bright object in the lower half of the image and the largest bright object in the upper half of the image against a predetermined value, wherein when the object in the lower half exceeds the predetermined value and the object in the upper half does not, a tag is located in the lower half of the image establishing that the image has been rotated.

In yet another aspect of the present invention, there is provided a method for scanning film mammograms after a crash of the system performing the scanning, the method including the steps of: providing a queue file listing examinations submitted but not fully scanned, each line of the listing having a counter prefix (CP); determining if there are examinations listed in the queue; determining if the counter prefix is zero for the first line; removing the first examination from the file if its CP>0 and ejecting all scanned films related to that examination; and processing remaining queued examinations in the file.

In an embodiment of this method for scanning mammograms after a system crash, the step of providing includes the step of generating a queue file prior to a crash of the system, the step of generating further including the steps of: entering examination data to the file, setting CP to 0; scanning the examination films, increasing the CP by one for each film; determining if the CP for the examination is equal to 4; removing the examination from the file if CP=4; checking for a separator film if CP is not 4; and deleting the examination from the file if a separator file is found during the step of checking. In addition this embodiment may also include the steps of: deciding if previously queued examinations are to be processed prior to the step of determining if the counter prefix is zero; processing new examinations if it is decided not to process queued examinations; and returning to the step of determining if the counter prefix is zero if it is decided to process queued examinations.

In another aspect of the present invention there is provided a method for scanning film mammograms and handling scanning failures, the method including the steps of: determining if an examination is a failed examination using predetermined criteria; creating a failed file for all examinations that have failed; ascertaining if there are failed examinations in the failed file; filling in information for a new examination using information stored in the failed file; and processing the examination.

In an embodiment of this method for scanning film mammograms and handling scanning failures, the method further includes the step of: entering examination data manually if in the step of ascertaining it has been determined that there are no examinations in the failed file; and returning to the step of processing. In this embodiment, the step of entering data manually may be effected even when there is data in the failed file.

In yet another embodiment of the method for scanning film mammograms and handling scanning failures, the step of creating a failed file includes the steps of: scanning a series of film mammograms; determining if the scanning is a failure; ejecting all films if the scanning is determined to be a failure; and adding the failed examination to the failed file.

In yet another embodiment of the method for scanning film mammograms and handling scanning failures, the method further includes the step of: processing continues normally if the scanning is not deemed a failure in the step of determining if the scanning is a failure.

In yet another aspect of the present invention there is provided a workstation system for scanning film mammograms, the system including a scanner operative to receive and digitize film mammograms from a patient. The system also includes a processing means for receiving digitized images from the scanner, the processing means being operative to evaluate the digitized images of the film mammograms so as to detect suspicious lesions therein and also operative for storing the digitized images. The processing means is further operative to analyze, orient and position the digitized images according to a pre-selected presentation scheme irrespective of the order and orientation in which the film mammograms were scanned by the scanner. Additionally the system includes output means in communication with the processing means for outputting the digitized images in the pre-selected presentation scheme. The output means may be a printer in communication with the processing means, the printer operative to produce a printout of the digitized images' identifying data and output data relating to the patient, the printout of the images being presented according to the pre-selected presentation scheme. Alternatively the output means may be a display in communication with the processing means, the display operative to display the digitized images according to the pre-selected presentation scheme. The output means may include both a printer and a display.

In yet another aspect of the present invention there is provided a workstation system for scanning film mammograms, the system including a scanner operative to receive and digitize radiological film mammograms from a patient. The system also includes a processing means for receiving digitized images from the scanner, the processing means being operative to evaluate the digitized images of the film mammograms so as to detect suspicious lesions therein and also operative for storing the digitized images. The processing means is further operative to recognize and indicate failed examinations when entering patient data and scanning film mammograms. Additionally, the system includes an output means in communication with the processing means for displaying information that an examination has failed. The output means may be a printer or a display or both.

In yet another aspect of the present invention there is provided a workstation system for scanning film mammograms, the system including a scanner operative to receive and digitize radiological film mammograms from a patient. The system also includes a processing means for receiving digitized images from the scanner, the processing means being operative to evaluate the digitized images of the film mammograms so as to detect suspicious lesions therein and also operative for storing the digitized images. The processing means is further operative to allow start up of the system after a system crash using pre-crash entered data obviating the need for reentering such data. Additionally the system includes an output means in communication with the processing means for displaying information relating to the pre-crash entered data. The output means may be a printer or a display or both.

### BRIEF DESCRIPTION OF THE DRAWINGS

The present invention will be understood and appreciated more fully from the following detailed description taken in conjunction with the drawings in which:

FIG. 1 is a block diagram of a prior art CAD system;

FIGS. 2A-2C are three schematic views of a mammogram workstation constructed in accordance with an embodiment of the present invention;

FIG. 2D is a schematic view of the conveyor and conveyance of the printout constructed according to an embodiment of the present invention;

FIGS. 3A-3B are isometric cut-away and enlarged cut-away views respectively of a body of a workstation constructed in accordance with another embodiment of the present invention;

FIGS. 4A-4D show schematic views of the standard presentation of the craniocaudal (CC) and mediolateral oblique (MLO) projections for right and left breasts;

FIGS. 4A′-4A′″, 4B′-4B′″, 4C′-4C′″ and 4D′-4D′″ schematically illustrate the various positions after flipping or rotating FIGS. 4A-4D respectively;

FIG. 5 shows a flow chart of the method according to the present invention for determining if flipping or rotation of an image has occurred;

FIG. 6 shows a flow chart of the method according to the present invention for determining the side and projection of a breast image;

FIG. 7 shows a flow chart of the method according to the present invention for handling system crashes; and

FIG. 8 shows a flow chart of the method according to the present invention for handling examination failures.

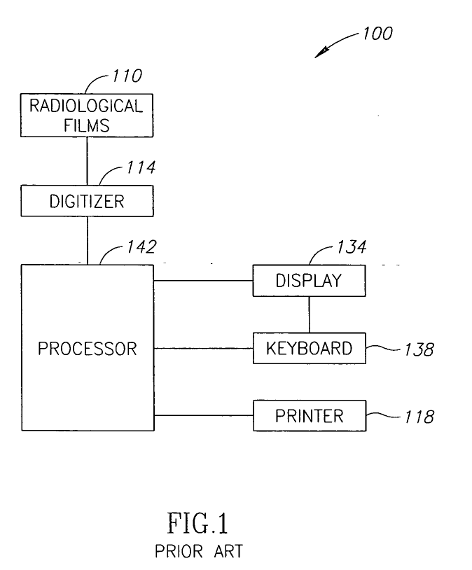

Similar elements in the Figures are numbered with similar reference numerals.

### DETAILED DESCRIPTION OF PREFERRED EMBODIMENTS

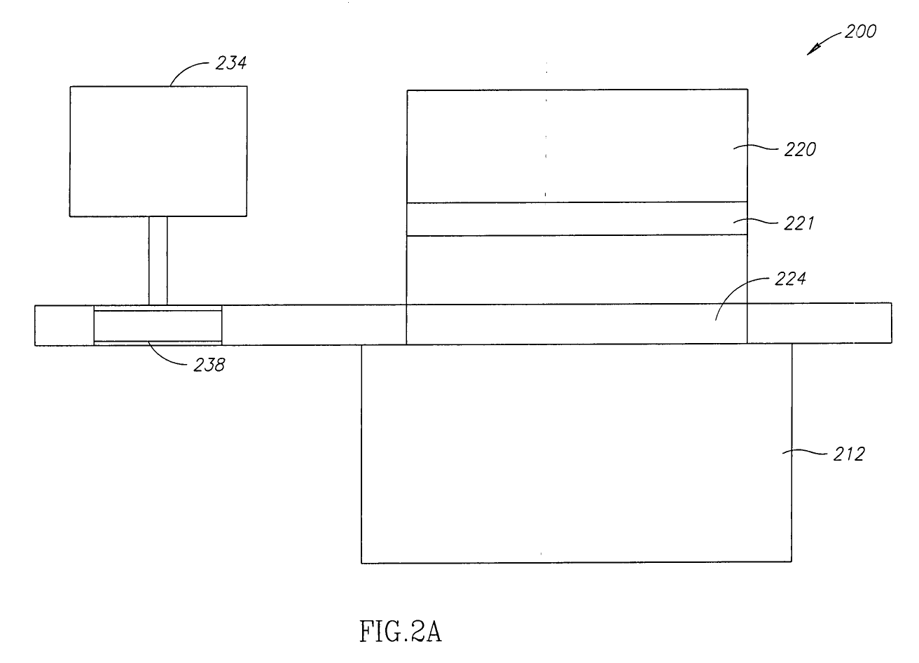

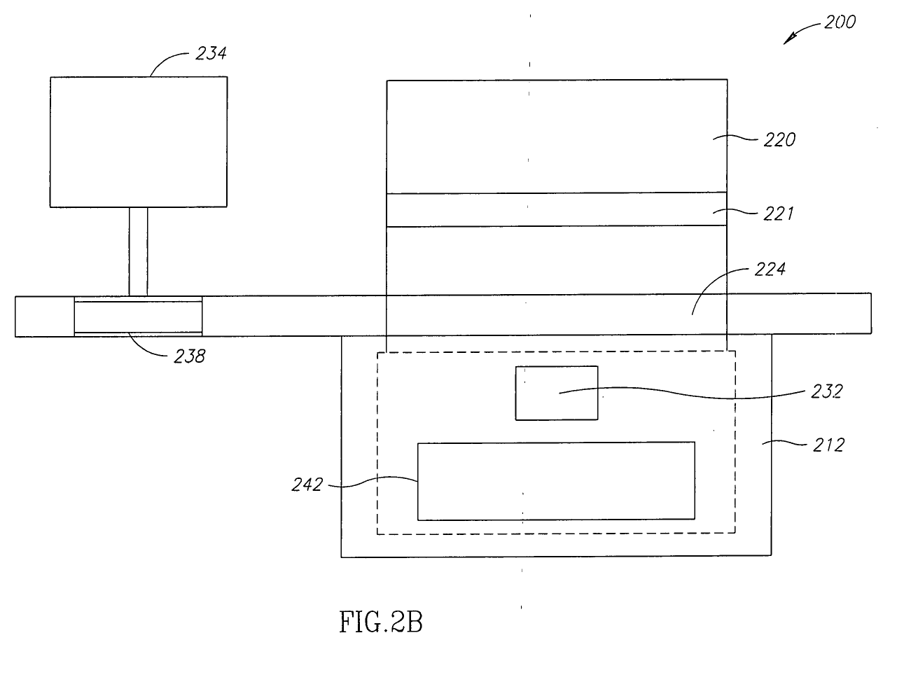

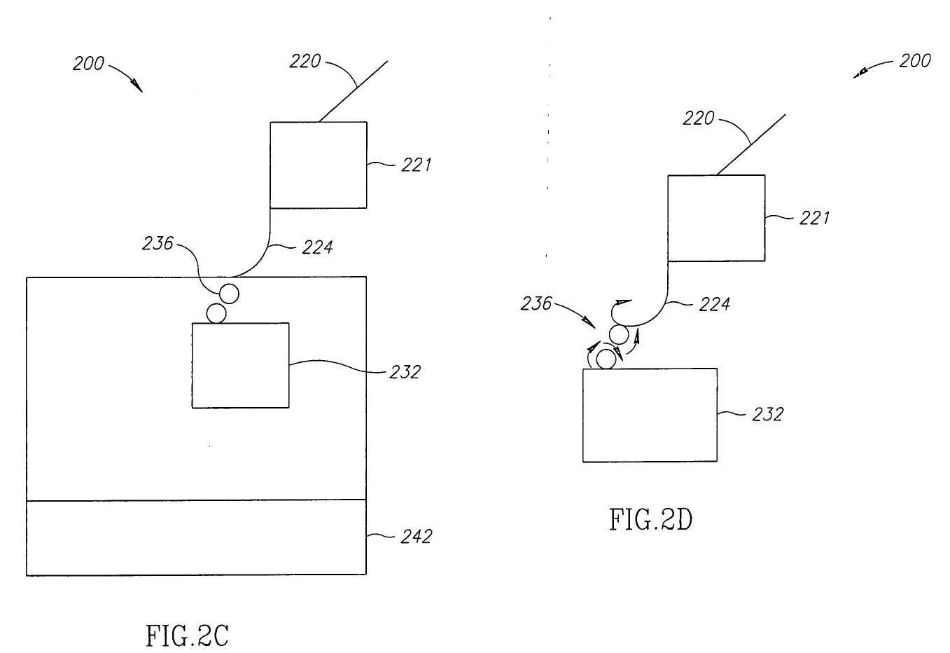

FIGS. 2A-2C, to which reference is now made, show various schematic views of a workstation, generally referenced as 200, with which the methods of the present invention described hereinafter may be employed. FIG. 2A is a full front view, FIG. 2B is a cut-away front view and FIG. 2C is a side view of the workstation. Workstation 200 includes a display 234, a keyboard 238 and a computer processor 242, the latter located within the body 212 of workstation 200. It also may include an input device (not shown), which may be a computer mouse, touch screen or other such devices.

Integrated with body 212 of workstation 200 is a scanner 221 which is in electronic communication with processor 242. A film feed 220 of scanner 221 is shown at the top of workstation 200. Radiological films containing mammogram images are placed in film feed 220 and scanned through scanner 221 from which digitized images are transferred to processor 242 and then displayed on display 234. The scanned films then drop into a collating station 224 of workstation 200. Without being limiting, a scanner that can be used is the Mammography Pro™ scanner produced by Vidar Systems Corporation.

The films of a patient are scanned one after the other by scanner 221 and after each film is scanned they fall onto the previously scanned film already lying in collating station 224. Generally four films of a patient, representing craniocaudal (CC) and mediolateral oblique (MLO) views of each breast, are scanned. Processor 242 receives the scanned digital images from scanner 221 and processes them so that they are all simultaneously displayed on display 234. It should readily be evident to one skilled in the art that in other workstation configurations a plurality of scanned films relating to a single patient can be processed and displayed sequentially one-by-one or in pairs or in a pre-determined manner.

When the four films are displayed together, the films are regularly placed in preselected positions. For example, the upper two pictures on display 234 can be the right and left craniocaudal (CC) views respectively while the bottom two views, the right and left mediolateral oblique (MLO) views, can be lined up directly below the respective CC views. Alternatively, films of the right breast can be displayed above the left breast with the right CC view over the left CC view and the right MLO view over the left MLO view. Other display orders are also possible.

Each of the displayed films include location markers circumscribing suspected abnormalities. Processor 242, using any of many algorithms known in the art, determines the existence of abnormalities. Examples of algorithms which can be used are discussed in U.S. Pat. Nos. 5,854,851 and 5,970,164 both to Bamberger et al, and both incorporated herein by reference in their entirety. The radiologist examines the displayed views, particularly the areas marked as suspicious lesions, before making a final diagnosis and/or prescribing a course of action.

Generally, prior to scanning a new set or sets of films, i.e. films relating to one or more patients, the operator, using keyboard 238, enters the one or more patients' identifier data. This typically includes but is not limited to name, age, identifier number, etc. This step obviates the need for using bar codes or adhesive stickers containing identifier data as is currently being done. After the digitized images of the scanned film mammograms of a patient have been stored in processor 242 they can be retrieved at any time by a radiologist for re-viewing by inputting the previously inputted patient identifier data. The identifier data of each patient is stored in the processor in an index file, hereinafter denoted as the patient. idx file, together with the image files of the scanned films relating to the patient.

Typically, a separator film is placed immediately after a patient's set of film mammograms in film feed 220. The separator film contains a preprinted pattern, graphical indicia, design or other identifier recognizable by the scanner and/or processor as indicating a separator film. In addition, or alternatively to a preprinted pattern, the separator can have a predefined edge, such as a textured or serrated edge, which differs from the edges of the previously scanned set of radiological films. The different shaped edge can be discriminated by the scanner as indicating a separator film.

After the separator film is scanned, processor 242 recognizes that the end of the set of film mammograms relating to patient Jones has been reached and that the next mammogram relates to patient Smith. Processor 242 then automatically instructs printer 232 to print the digitized images of patient Jones displayed on display 234, including the marked suspected abnormalities shown thereon. The printout of the displayed digitized images is then delivered directly and automatically to collating station 224 by a conveyor 236. The conveyor 236 used in FIG. 2C is a system of rollers 236. In collating station 224, the printout falls onto its associated set of film mammograms that have been scanned previously and from which the displayed digitized images have been generated. Finally, the separator film drops from scanner 221 onto collating station 224 where it forms a complete collated package with the film mammograms and associated printout for patient Jones. The procedure is then repeated for patient Smith and all succeeding patients.

It should be noted that the separator film has two functions. It indicates to the processor that the next film to be scanned relates to a different patient and should be associated with different identifier data. Additionally, at a later stage after film/printout collation has been completed at collating station 224, it indicates to the technician filing the radiological films and their associated printout that the collated material for one patient has ended and data for a new patient lies below. Accordingly, the technician knows to file the data between a pair of separator films in a single storage container, generally a physical folder, for storage in the medical records department, the radiology department, or elsewhere.

Processor 242 can be pre-programmed to stop scanner 221 from scanning when it determines that no identifier data has been supplied.

In another embodiment, identifier data could be entered during the process of generating the film mammograms. Such data could be inputted and coded directly and automatically onto the film mammograms as they are being processed. When scanner 221 scans the films, the identifier data can be read and stored in processor 242 with the digitized images.

In yet another embodiment, a set of film mammograms may be scanned by scanner 221, digitized and displayed on display 234. Then using keyboard 238, the radiologist or technician instructs printer 232, which is in communication with processor 242, to print the digitized images displayed on display 234, including the marked suspected abnormalities shown thereon. The displayed image printout is then delivered directly and automatically to collating station 224 by a conveyor 236. The conveyor used in FIG. 2C is primarily a system of rollers 226. In collating station 224, the printout falls onto its associated set of films that have been previously scanned and from which the displayed digitized images have been generated. After the printout of the digitized images has automatically been placed on the set of scanned films, a separator film is inserted into film feed 220 and scanned. The processor detects the separator film and knows that any subsequent film mammograms belong to another patient. The separator then drops onto the film mammograms and printout lying in collating station 224.

While the separator film that has been discussed above, and will be discussed below, has been described in terms of radiological films having predetermined designs or patterns or films having distinctive edges, separators with other distinguishing features or marks may also be used.

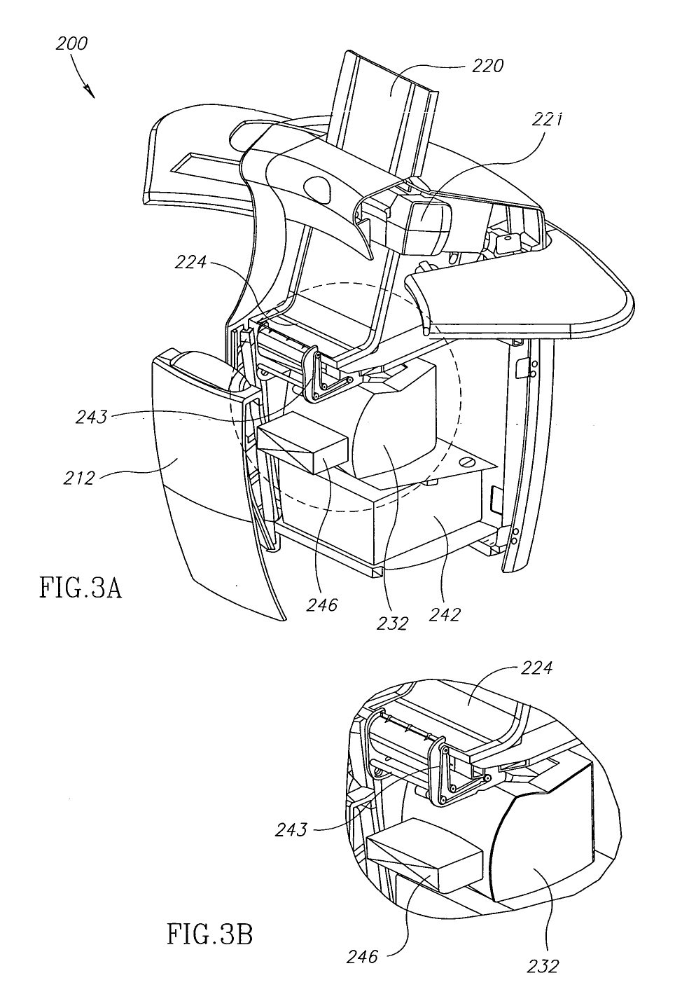

It should be noted that for purposes of simplicity, processor 242 has been shown in FIGS. 2B-2C (and below in FIGS. 3A-3B), and described in conjunction therewith, as a single unit. In reality it represents a complete “processing means” that includes both hardware and software systems which are in electronic communication with scanner 221, printer 232, and display 234, coordinating their activities. Processor 242 also includes a “means for synchronizing” which synchronizes the scanning done by scanner 221 and printing done by printer 232. Processor 242 also contains a memory for storing digitized images and patient input data, the latter provided inter alia by an input device such as keyboard 238. In what is described herein, including in the claims, “processor” and “processing means” will be used synonymously without any intent at distinguishing between them.

FIG. 2D to which reference is now made shows in a schematic fashion the conveyance of the printout from printer 232 over a series of rollers 236 into collating station 224 where rollers 236 serve as the conveyor 236 of the printout.

Reference is now made to FIG. 3A which shows an isometric view of workstation 200 with a cut-away view of its body 212 and FIG. 3B which shows an expanded view of printer 232, conveyor 236, which here is a simple paper guide 243, and collating station 224.

FIG. 3A shows printer 232, including paper station 246, which generates a printout of the scanned digitized images. Paper guide 243 guides the printout from printer 232 to collating station 224. FIG. 3B shows an expanded isometric view of printer 232, paper guide 243, and collating station 224. Paper guide 243 acts as a conveyor 236 just as roller 236 does in FIGS. 2C and 2D. It should be evident that constructions other than rollers 236 shown in FIGS. 2C and 2D and paper guide 243 shown in FIGS. 3A and 3B can also serve as a conveyor of the printout from printer 232 to collating station 224. For example, and without being limiting, the many different types of paper conveyor systems in photocopier machines can be adapted for use in workstation 200.

In general, an algorithm used by the processor of the workstation recognizes each of the scanned films as relating to the left or right breast of the patient and to a CC or MLO projection of the breast. It further recognizes when a film has been flipped or rotated prior to scanning. After recognition, the processor takes action to correct for inadvertent flipping and rotation of the films, determines the breast side and projections, orders the left and right breast projections according to a pre-selected order, and displays the views in the pre-selected order on display 234. This automatic sequencing replaces time-consuming sorting and data reentering by a technician and reduces human error.

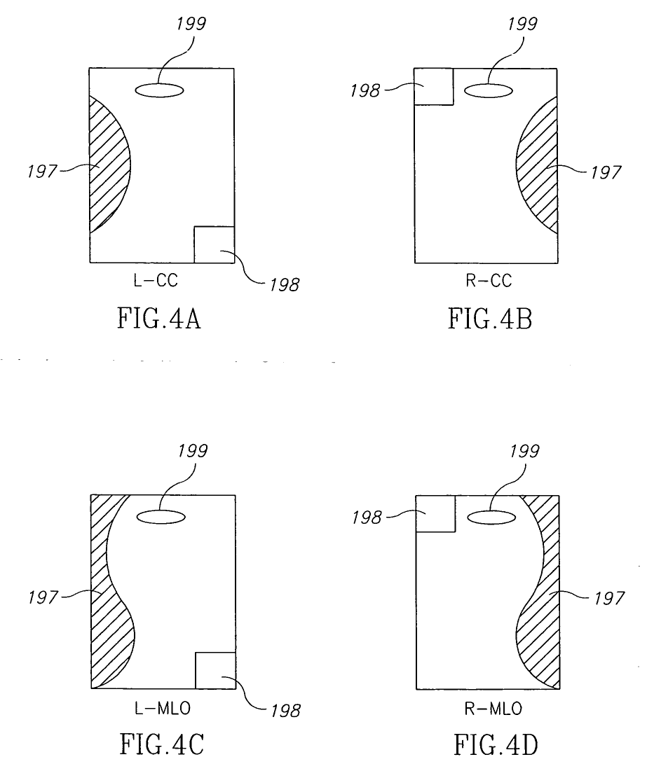

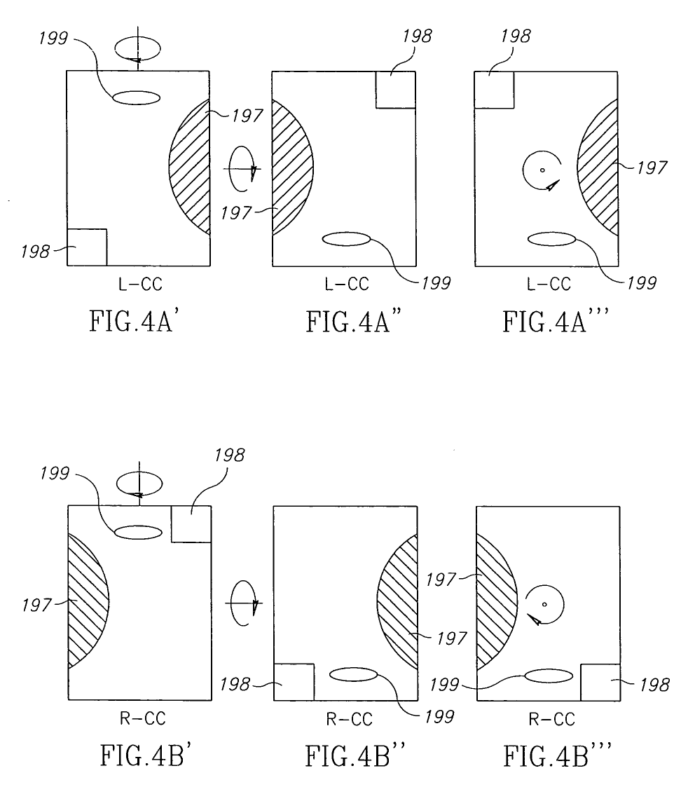

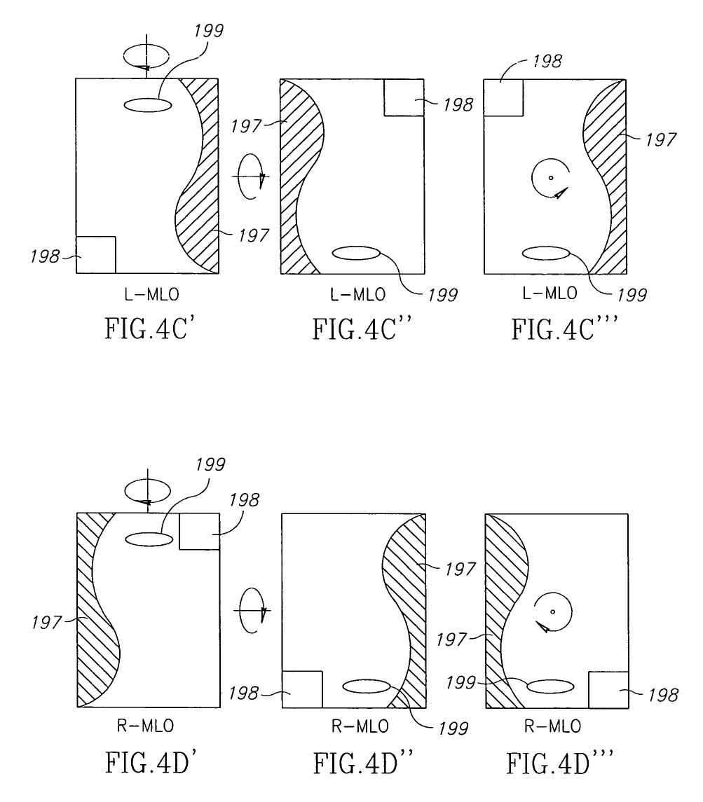

In order to better understand the method for determining how the proper orientation is determined reference is now made to FIG. 4A-4D where the “standard” light box orientation of a right craniocaudal (R-CC), left craniocaudal (L-CC), right mediolateral oblique (R-MLO) and left mediolateral oblique (L-MLO) projections are displayed. Each projection 197 has a label 198 that generally contains patient identification information and a tag 199 that generally contains information about the projection and whether the projection is of a left or right breast projection. The tag 199, represented in the figures only by an ellipse in order that the rotations and flippings in FIGS. 4A′-4D′″ can be more easily understood, actually consists of a letter R or L (right or left) and generally also a group of letters indicating the side and projection (e.g. R-CC or L-MLO). Typically, both the tag and label appear white on the film and scanned image. Sometimes, the tag is comprised of black letters on a white background. For left breast projections, the label 198 is in the lower right corner of the film, and the tag 199, indicating the projection and whether it relates to a left or right breast, is shown in the upper half of the film. For both R-CC and R-MLO projections the label 198 is positioned in the upper left corner and the tag 199 is again positioned in the upper half of the film. The contours of the CC and MLO projections 197 are shown in their typical positions in FIGS. 4A-4D. Any rotation would place the tag in an improper position vis-a-vis the non-rotated contour and any flip would place the label in an improper position vis-a-vis a non-flipped contour.

Reference is now made to FIGS. 4A′-4A′″ which show the results of FIG. 4A being flipped along a vertical axis, being flipped along a horizontal axis, and being rotated along an axis perpendicular to the plane of the paper and through the center of the film, respectively. Similarly, reference is made to FIGS. 4C′, 4C″ and 4C′″ which show the results of FIG. 4C being flipped along a vertical axis, being flipped along a horizontal axis, and being rotated along an axis perpendicular to the plane of the paper and through the center of the film, respectively. The same operations have been applied to FIGS. 4B and 4D thereby generating the Figures in FIGS. 4B′-4B′″ and 4D′-4D′″ respectively. It should be noted that none of the flipped or rotated images is identical to their parent image or any of the other images in FIGS. 4A-4D.

The letters below each of FIGS. 4A-4D and 4A′-4D′″ indicate the breast side and projection. They are actually located in the films and digitized images at the position where the ellipses have been shown. Symmetrical ellipses have been used to represent the unsymmetrical letters to more easily depict the results of the transformation operations shown in FIGS. 4A′-4D′″.

In what is discussed herein, the term “pre-selected presentation scheme” relates to 1. the standard orientation of individual film mammogram projections, such as those described in conjunction with FIGS. 4A-4D and to 2. the order, orientation and position of the various L-CC, R-CC, L-MLO and R-MLO mammogram views when they are presented for “reading” by a radiologist.

Image Flipping and Rotation

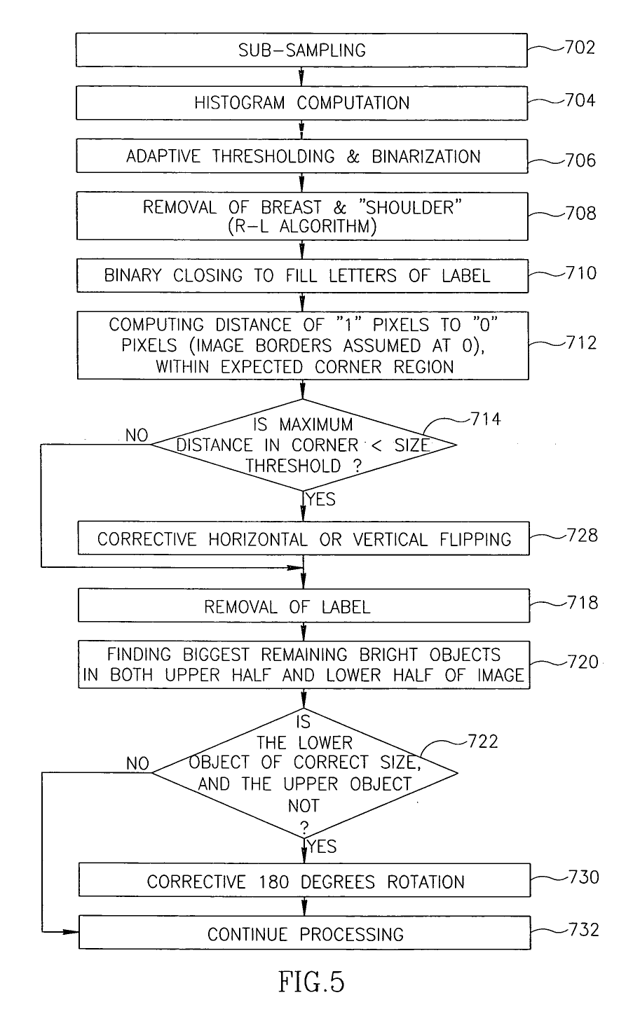

In FIG. 5, to which reference is now made, a method according to the present invention is shown for determining if a film has been inadvertently flipped or rotated prior to scanning. The method ensures proper orientation of the mammogram digital image. In step 702, the film is sub-sampled, that is a number of contiguous pixels are sampled together and a histogram is generated 704. Since high resolution is not required to determine if an image is of a left or right breast or if it is a CC or MLO projections, sub-sampling does not effect these determinations. Sub-sampling may be viewed as an optional step.

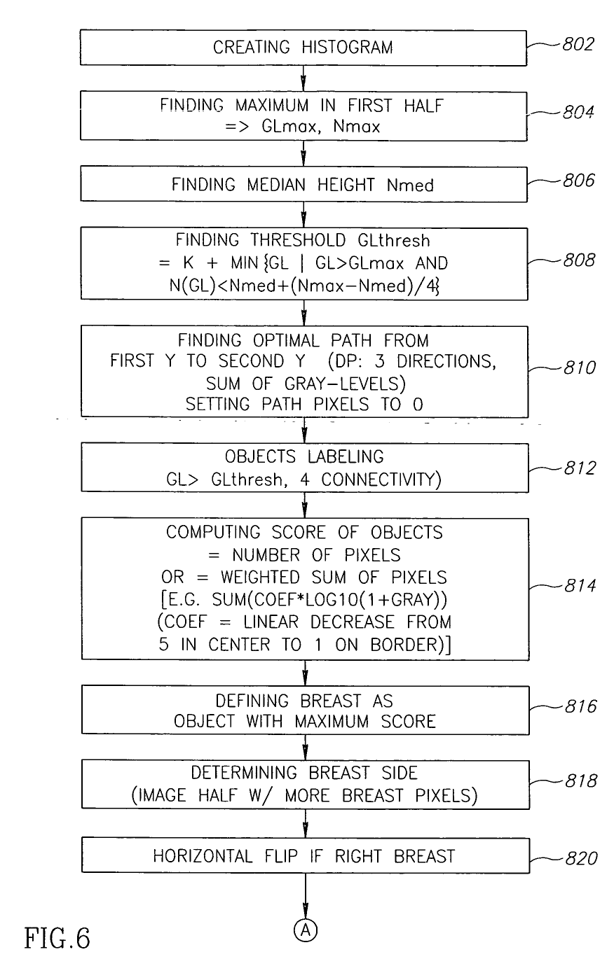

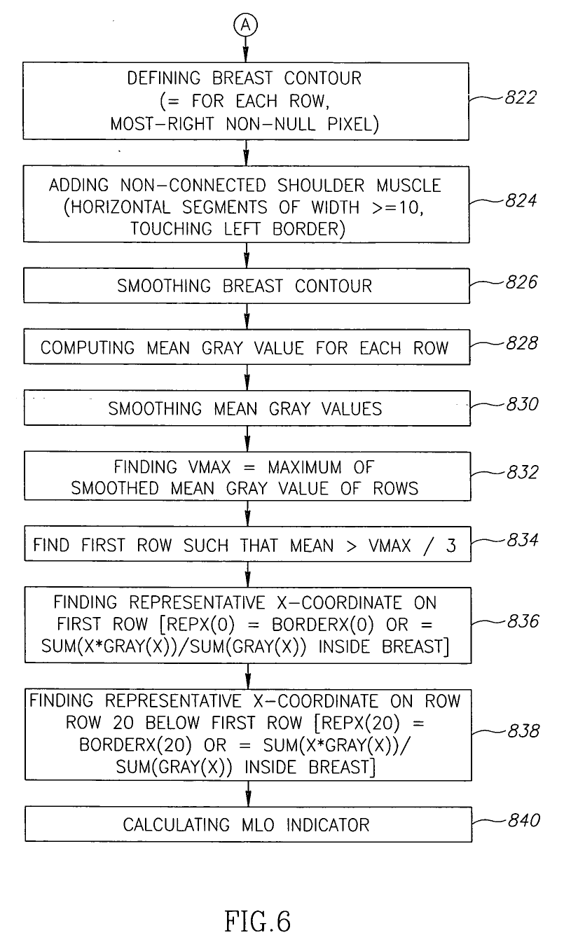

The histogram generated in step 704 is a plot of number of pixels versus gray level (GL). The histogram is used to develop 706 an adaptive threshold. This threshold gray level is adapted separately for each scanned film, since the backgrounds of different films do not necessarily have the same gray levels. The choice of the threshold GL can be made in any number of ways known to those skilled in the art. One way is discussed in conjunction with FIG. 6 below steps 802-808.

After determining 706 an adapted gray level threshold for an image, the image is binarized 706. Pixels, or sub-sampled groups of pixels, having gray values in excess of the determined threshold receive a value of “1” and pixels, or sub-samples groups of pixels, having gray values below the threshold are given a value of “0”.

The white area of the binarized image representing breast and shoulder muscle, the latter typically noted only in MLO projections, is then removed 708. These tissues appear as large contiguous bright areas in the image. Removal can be effected in any number of ways. One way can be to determine if the image is of a right or left breast and then assigning “0” values to the located breast image. Determining if a breast is a right or left breast is discussed below in conjunction with FIG. 6, steps 812-818. This removal theoretically leaves only the zeroed film background with bright areas arising from the presence of the film's label and tag. There may be other stray light areas (binary values “1”) more or less haphazardly strewn around the image. In almost all instances, the size of these bright areas will be smaller than the bright areas representing the tag and the label.

Detection of a flipped film then proceeds. Because the label of the film always appears as a white rectangle in the bottom right or upper left of a film (as in FIGS. 4A-4D), those areas of the film are searched. First, however, the letters forming the patient identification data in the label which appear black are closed 710, that is they are given binary values of “1”. The entire label therefore appears to be white for flipping/rotation detection purposes.

The following describes only one of many possible methods intended to determine if there is an object of label-like size in an expected corner of the digitized image.

The label has edges that are contiguous with the background of the image or represent the physical borders of the film. The pixels are contiguous, but outside, the label are generally dark and have been given a binary value of “0” The distance from the nearest edge or physical border of every pixel in the potential label, that is every pixel in the bottom right or upper left corners, is evaluated 712. The distance between each pixel in the potential label (with a value of “1”) and the nearest background pixel (having a binary value of “0”) is evaluated and the maximum such distance is determined. If the distance for the pixel with the maximum such distance is less than a predetermined size threshold, then the image has been flipped. It should readily be understood that the size threshold is dependent on the known physical size of the label, typically half the width of the label.

Corrective horizontal or vertical flipping along a horizontal and vertical axis bisecting the image is effected 728 if the maximum distance is less than a predetermined size threshold. If the distance for the pixel with the maximum distance is greater than the predetermined size threshold, the image has not been flipped and corrective action is not required.

In place of the required corrective flipping, any flipping plus a corrective rotation as discussed with respect to tag identification below may be used to orient the label in its proper position.

After the determination of whether an image has been flipped or not and corrective action, if required, has been effected, steps intended to determine inadvertent rotation are applied. This is done by searching for the tag indicating R-CC, L-CC, R-MLO, or L-MLO. As shown above in FIGS. 4A-4D, these tags are always positioned in the upper half of the image.

As a first step, the label located in steps 710-714 is removed 718 by assigning a binary value of zero to it, thereby leaving a digitized image that should be completely dark (i.e. with binary values of “0”) except for the area where the tag is located. The image is then searched 720 for the largest bright objects in both the upper and lower halves of the image. An evaluation 722 is made as to whether the largest bright object in the lower half of the image is of the correct size, i.e. greater than a predetermined threshold size, to reflect a tag or not. If there is such an object and the brightest object in the upper half is not of the correct size, that is less than the predetermined threshold size, the film when scanned was inadvertently rotated. A corrective 180° rotation is effected 730 along an axis perpendicular to the image and passing through its center. If the upper object is of the correct size, it is assumed that the film was properly scanned and not improperly rotated. Corrective action is not expressly warranted. Additionally, if both objects are not of the correct size nothing is done.

Determination of Breast Side and Projection

The present invention provides for an automatic determination as to whether the digitized image produced by scanning a film mammogram is that of a left or right breast and as to whether the image is a CC or MLO projection. These two determinations allow for the automatic reordering of the film in the pre-selected presentation scheme required for the physician's examination.

Reference is now made to FIG. 6 wherein a method is shown for automatically recognizing if a scanned mammogram is that of a right or left breast and if it is a CC or MLO projection. The method can be thought to consist of five stages: A. image thresholding, B. separating the breast from the border of the film, C. determining breast side and contour, D. improving the basis for calculation of border slope and E. computing a projection indicator. The method may be executed at very low resolution, 25 dpi for example.

Image thresholding begins by constructing 802 a histogram where the number of pixels is shown as a function of gray values. The maximum in the first half of the histogram is determined 804, thus providing the number of pixels N at the maximum, Nmax, and the gray level (GL) at the maximum, GLmax. Only the first half of the histogram is searched; this represents the darker part of the film. Any maximum in the second half of the histogram represents only the lighter portion of the film, and includes primarily the breast, tag and label images.

The median number of pixels is then determined 806. The median number of pixels Nmed and the maximum number of pixels Nmax determined in step 804, are then used to determine 808 the threshold GL, GLthresh. There can be a number of ways to do this but an exemplary, non-limiting way can be by taking a GL threshold where GL thresh=min{GL|GL>max AND N(GL)<Nmed+(Nmax−Nmed)/4}. Alternatively, a constant may be added to this formula.

Use of the median in the above formula moves the GL thresh away from the histogram maximum and therefore away from being buried in the dark background. Nmed also ensures that the GLthresh will still be far enough away from the bright section of the histogram which represents tissue pixels.

It should be readily understood by one skilled in the art that the formula given above for the number of pixels as a function of gray levels is just one of many possible formulas that could be used. It is exemplary only and not intended to be limiting.

Once a threshold GL, GLthresh, is determined, the film is binarized with all pixels above GLthresh being given a value of “1” and all pixels below that value being given a value of “0”.

If the image of the breast touches or extends beyond the image border, the breast is separated 810 from the image border. This may be done by using dynamic programming techniques well known in the art. These techniques determine an optimal path from a first Y value on the top border of the image to a second Y value on an opposite (bottom) border. The dynamic programming techniques used typically employ a three-directional path which optimizes the sum of the gray levels along that path. The pixels along that path are given values of 0 and are considered to be background.

Determining the breast contour and side begins with labeling 812 objects having a GL>GLthresh using a connectivity of four. A score for the labeled objects is computed 814. Without being limiting, scoring may be effected by determining the number of pixels in an object. Alternatively, the score may be computed on the basis of a weighted sum over all the pixels in the object, where the sum is the sum(coef*log₁₀(1+gray)). The weighting coefficient, coef, may be defined as the linear decrease from 5 in the center of the object to 1 on the border of the object. It should readily be understood by one skilled in the art that other sums may be used to calculate scores with or without weighting coefficients. The sums typically will be functions of gray levels.

The breast is then defined 816 as the object with the maximum score and the breast side is determined 818 to be the half of the image with more breast pixels. If it is determined that the breast is the right breast, the image is flipped 820. This permits standardized processing for both left and right breasts in all subsequent steps 822-840 needed to detect the projection. The breast contour is then defined 822 as the most-right, non-null pixel for each row.

Further processing is required to determine if the projection scanned is a CC or MLO projection. This begins with adding 824 any unconnected shoulder muscle; shoulder muscle generally appears only in MLO projections. This step is required so that the slope of the MLO, generally calculated at the shoulder muscle region in an MLO projection, can be calculated in step 840 below. Typically, the slope of an MLO projection is greater than the slope of a CC projection according to a formula such as the one discussed with step 840. The latter typically does not contain shoulder muscle. These unconnected muscle portions are bright areas in the left half of the image. Where there are horizontal segments of brightness above a GLthresh (as described above) and larger than some predefined minimal width (e.g. ≧10 pixels) touching the left border, it is assumed to be breast or unconnected muscle tissue.

The breast contour is then smoothed 826 typically using a symmetrical median filter of size 11. The filtering size is exemplary only and is not to be considered limiting. Smoothing techniques known in the art, such as low pass filtering, can be used.

Improving the basis for calculation of the border slope for CC images begins by computing 828 a mean gray value for each row of the located breast. This is followed by smoothing 830 the mean gray values using a median filter of radius±10. Again, the filter size is exemplary only and is not to be considered limiting.

A vmax, which is the maximum of the smoothed mean gray values of the rows used in step 828 is then computed 832. The rows are searched 834 so that a first row is located where the mean>vmax/3. Criteria other than a mean>vmax/3 may also be used. Mean>vmax/3 eliminates small muscle, non-breast tissue regions along the left border in CC projections. This smoothing ensures that the slope of a CC projection computed in step 840 below, is computed along the breast contour and not along small stray muscle areas.

Finally, the projection indicator is computed. A representative x coordinate, RepX(0), on the first row is found 836. The first row is the row that has been determined in step 834. Without being limiting, RepX(0) could be the x coordinate of the border pixel between the breast tissue and background in this row. It could also be some weighted x value such as the sum(x*gray(X))/sum(gray(x)), i.e. the sum of the x values for all pixels in the row determined in step 834 which are located inside the breast, multiplied by their gray values and divided by the sum of the gray values. Then a representative x coordinate, RepX(20), on row 20 below the first row, is found 838. Typically, this could be the x coordinate of the border pixel between breast tissue and background in this twentieth row or it could be some weighted x value such as the sum(x*gray(X))/sum(gray(x)), i.e. the sum of the x values for all pixels in the twentieth row located inside the breast multiplied by their gray values and divided by the sum of the gray values. Finally an MLO indicator is calculated 840 and a determination of whether the contour is a MLO or CC is made. A typical such indicator would be Rep(0)−Rep(20)+k, where k is a constant which sets the CC/MLO threshold to zero.

From an examination of the contour of a CC and an MLO image such as those in FIGS. 4A-4D, it is clear that the sign of a CC slope generally differs from that of an MLO slope. However, it should also be clear that in all cases the slope is such that the slope of an MLO projection is greater than the slope of a CC projection.

Based on the determination made as to the side and contour of the digitized images, the images are ordered according to a pre-determined presentation scheme prior to display or printout.

Failed Examinations and Crashed Systems

In what is discussed herein below, the term “examination” is a set of film mammograms taken for one patient during a single visit to the mammography department. As noted above, generally this is four films, consisting of L-CC, R-CC, L-MLO and R-MLO views. However, the number may be more or less than four depending on the needs of the radiologist or the health status of the patient. For example, if a woman has had a mastectomy the number of films is fewer than four.

In order to reduce the need to reenter patient data and films after system crashes and failed examinations—failed examinations being described below—the present invention provides a method for retaining inputted data for patients for which the system fails or after a system crash, avoiding having to remove the films in order to place them again in the scanner. In order to understand how this occurs, a discussion of the way the system's processor handles queued examinations is required.

Queued Examinations and Crashed Systems

A continually updated list of queued examinations is maintained in the processor and this list is saved at all times. The list is maintained in a file, herein denoted as a Queue.idx file, which is used when rebooting after a system crashes. The format of this file is generally similar to the format of the basic Examination Index File/Patient File (Patients.idx), each examination being represented by one line in the file, but additionally including a counter prefix (CP) added at the beginning of each line.

The Queue.idx file is managed as follows:

At the moment a button on the workstation console is pressed to confirm the positioning and placement of films for scanning, the examination name, i.e. patient identification data, with CP=‘[0]’, is added to the Queue.idx file. Each time scanning of a film begins, the CP in the first line of the Queue.idx file is incremented.

At the moment scanning of the films relating to an examination/patient is over, the first line of the Queue.idx file is removed. This occurs either when scanning of the fourth film begins or when a separator is detected, whichever is earlier.

After a system crash, the system first determines if a Queue.idx file is present. If it is present, the user is asked if he wants to process the previously queued cases. If the user answers positively, the Queue.idx file is loaded and displayed as the queue of waiting cases. The first line of the file is identified as the examination in process and its CP is used as a basis for correctly processing the examination. If the CP of the first line is not zero, it means that the process of an examination was interrupted by a system crash. As a consequence, the processing of the current examination is aborted, all films until the next separator, up to a maximum of four films, are automatically ejected from the scanner and the examination is declared a failure. The actions listed below for failed examinations are effected and a message indicating that a problem has occurred and that the examination should be resubmitted is displayed.

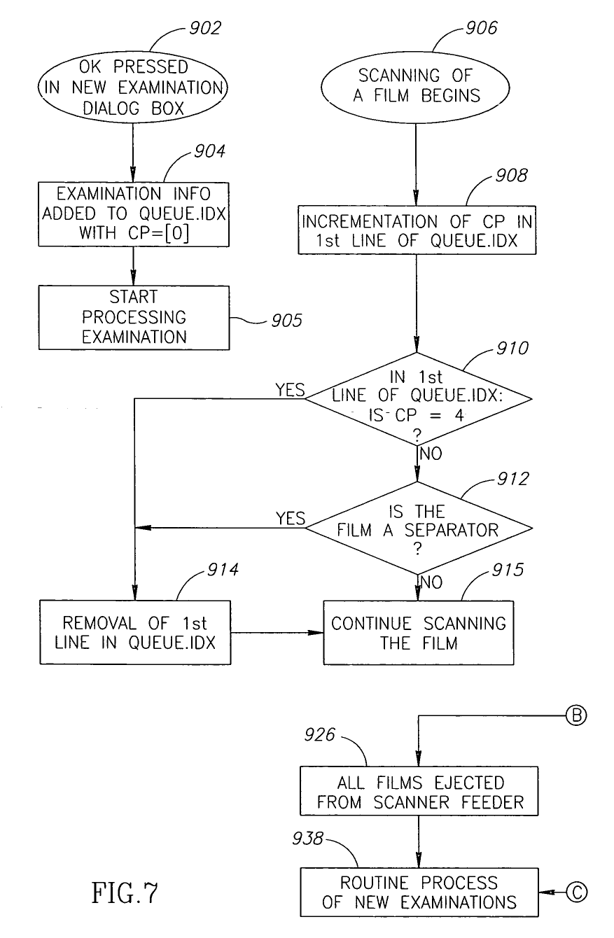

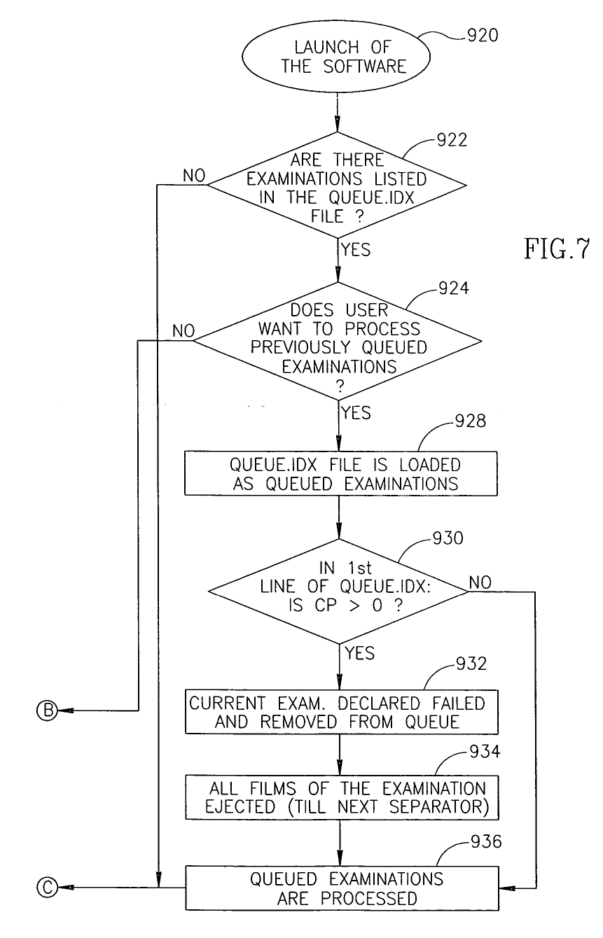

In order to better understand the above described method for handling system crashes, reference is now made to FIG. 7 which presents a flowchart of the method for handling system crashes according to the present invention. The CAD system used may be the one described in conjunction with FIGS. 2A-3B although the method may be incorporated into other CAD systems as well. What is described herein below is presented using features of the workstation shown in FIGS. 2A-2B.

When routinely processing mammogram films, the OK button in a New Examination dialog box is pressed 902 and examination information is added to the Queue.idx file (QIF) setting 904 the counter prefix (CP) at zero. After the counter prefix is set to zero, processing of the examination starts 905.

A set of mammogram films and a separator film are scanned 906, and as each film of the set is scanned, the CP is incremented 908 by one in the first line of the QIF. A determination is then made 910 if the CP of the first line of the QIF is equal to four. If the answer is yes the first line in the QIF is removed 914 and scanning of the film continues 915. If the answer is no, a determination is made 912 if the film is a separator film. If the film is a separator film, the first line in the QIF is removed 914. If the film is not a separator film, scanning of the film of the examination/patient continues 915.

After a crash, software constructed according to the method of the present invention is launched 920 in the processor of the workstation.

A determination is made 922 if there are examinations listed in the QIF. If the QIF is empty, routine processing of new examinations occurs 938. If the QIF is not empty, the user is asked 924 does he want to process previously queued examinations. If the answer is no, all films are ejected 926 from the scanner and the processor continues regular processing 938 of new examinations. If the answer is yes, the QIF file is loaded 928.

The first line of the QIF is then checked 930 to see if CP>0. If the answer is no, all queued examinations are processed 936 and then there is a return to routine processing 938.

If CP>0, the current examination is declared failed and removed 932 from the queue. All films up to the next separator film are ejected 934. The remaining queued examinations are then processed 936 and then routine processing 938 of new examinations begins.

Failed Examinations

When either a film feeding, a film orientation or a film size problem is detected, the current examination is deemed a failed examination. All films until the next separator film, up to a total of four films, are ejected.

Various error messages are displayed or printed after a failed examination indicating one or more reasons for the failure. Additionally, rules for resubmitting films may also be displayed or printed.

The failed examination is transferred to the ‘done’ list which appears on the console screen and noted thereon as a failed examination. The failed examination is added to a Failed.idx file.

Typical processing failures include:
A non-authorized film size is detected. This includes the case where a small size mammogram is placed 90 degrees out of phase in the feeder, as well as the case of shifted double-feeding, that is partial overlapping films.
A third image of the same breast is detected.
Two films were scanned together so that total overlap occurred. Such an event is detectable because of the abnormal darkness of the image or the absence of a viewable label or tag.

According to the present invention, failed examinations are reprocessed as follows. The list of failed examinations is saved in the Failed.idx file to allow reprocessing of those examinations without reentering the demographics of the patient. The format of this file is similar to that of the Examination Index File (Patients.idx file) but also includes a date and time (DT) prefix added to each line. The DT prefix indicates when the examination was registered in the Failed.idx file. The examination is added to the Failed.idx file at the moment the examination is completed, generally when a separator film is identified.

A line (examination) is deleted from the Failed.idx file after a predetermined time period, typically a few days. Checking for lines to be deleted is done each time the New Examination button on the console is pressed.

In the New Examination dialog box of the system discussed in conjunction with FIGS. 2A-3B, a Failed Examination control area is added. It contains two buttons (Next, Previous) which are available to fill all fields in the dialog box with the demographics of a failed examination. An additional Blank button empties all fields to allow manual entry of the information.

When the New Examination dialog box is opened, the fields are filled by default using the first examination listed in the Failed.idx file. This represents the oldest failed examination in the list. When the fields of a failed examination are filled, they can not be modified; they can only be blanked through the Blank button. When a failed examination is selected, it is removed from the Failed.idx file at the moment the OK button is pressed.

When the Failed.idx file is empty, the failed examination control area is disabled. The Next and Previous buttons are enabled, respectively, if the failed examination presently selected is not the last or the first in the list.

The Blank button is enabled, only if a failed exam is selected. After the Blank button is pressed, only the Next button remains enabled to select the first examination in the Failed.idx file.

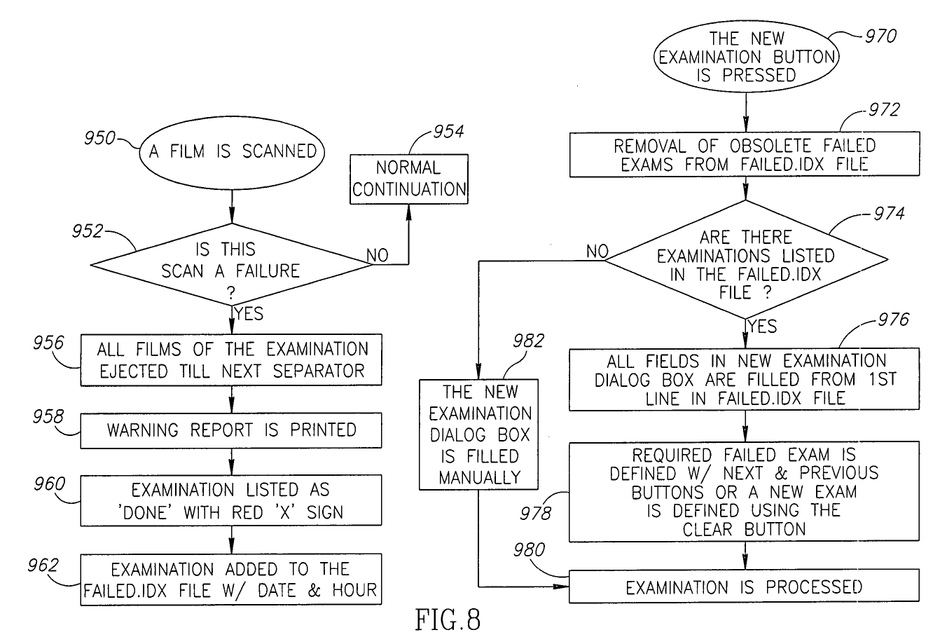

In order to better instantiate the failed examination cycle, reference is now made to FIG. 8. Routinely, a film is scanned 950. Evaluation 952 of this scan is made to ascertain if a failure has occurred, that is for example is the film of a non-standard size, is there a double feed with full overlap, is this a third film showing the same breast, etc. If the evaluation gives a negative result, normal processing continues 954. If the evaluation finds that there has been a scan failure, all films up to the next separator are ejected 956. A warning report is printed 958 and the examination is indicated 960 as failed on the appropriate list on the console screen. The examination is added 962 to the Failed.idx file (FIF) with an indication of the date and time of failure.

If a failure has occurred and new examinations are to be processed a new examination button is pressed 970 and new examinations are scanned 970. Obsolete failed exams, that is those that have been in the FIF file for a predetermined time period, are removed 972 from the FIF.

It is then determined 974 if there are any remaining failed examinations in the FIF. If yes, all fields in the New Examination dialog box are filled 976 from the first line in the FIF.

The required failed exam is selected 978 using the Next and Previous buttons or a new examination is defined 978, that is entered, using the clear button. The examination is then processed 980.

If it is determined 974 that there are no remaining failed examinations in the FIF, the New Examination dialog box is filled 982 manually and a routine new examination is processed 980.

The failed option has the advantage that input data is retained, reentering patient identification and demographic data is not required, and direct notification of a failure is received automatically.

The present invention above has been discussed in terms of the workstation and processor thereof described in conjunction with FIGS. 2A-3B. However, it should be evident to one skilled in the art that other workstations can also be used. The method for determining flipping or rotation of films, the method for determining if a digitized image is of the right or left breast, the method for determining if the image is that of a CC or MLO projection and the method for use in a processor that eliminates the need for data reentry after system crashes and assists in controlling failed examinations may all be applied to workstations other than the one discussed in conjunction with FIGS. 2A-3B.

It will be appreciated by persons skilled in the art that the present invention is not limited by what has been particularly shown and described hereinabove. Rather the scope of the invention is defined by the claims that follow.

1. A method for processing film mammograms, said method including the steps of:
scanning a set of film mammograms, thereby to obtain digitized images of the film mammograms;
storing the digitized images in a memory;
preparing the digitized images for display by performing an analysis of the images in order to determine if they are properly adapted for a pre-selected presentation scheme; and
bringing any improperly adapted images into their proper presentation scheme before displaying the images.

2. A method according to claim 1 wherein said step of preparing includes the step of determining whether the digitized images are properly oriented.

3. A method according to claim 2 wherein said step of determining includes determining whether a digitized image has been inadvertently flipped.

4. A method according to claim 2 wherein said step of determining includes determining whether the digitized image has been inadvertently rotated.

5. A method according to claim 1 wherein said step of preparing includes the step of determining appropriate parameters for properly positioning the digitized images.

6. A method according to claim 5 wherein said step of determining includes determining whether a digitized image is an image of the left or right breast.

7. A method according to claim 5 wherein said step of determining includes determining whether a digitized image is a craniocaudal (CC) or mediolateral oblique (MLO) projection.

8. A method for processing film mammograms, said method including the steps of:
scanning a set of film mammograms, thereby to obtain digitized images of the film mammograms;
storing the digitized images in a memory;
determining, for each digitized image, if the image represents a left or right breast;
preparing the digitized images for display by performing an analysis of the images in order to determine the projection of each digitized image; and
using the determined breast side and projection of each image to display the digitized images according to a pre-selected position irrespective of the order in which the film mammograms were scanned.

9. A method for processing film mammograms, said method including the steps of:
scanning a set of film mammograms, thereby to obtain digitized images of the film mammograms;
storing the digitized images in a memory;
preparing the digitized images for display by performing an analysis of the images in order to determine if each image is in standard orientation; and
using the analysis of the image to display the digitized images in the standard orientation irrespective of the orientation in which the film mammograms were scanned.

10. A method according to claim 9 wherein said step of preparing includes the step of determining if the image was scanned after being inadvertently flipped.

11. A method according to claim 10 wherein said step of preparing, further includes the steps of:
providing a binarized digitized image;
removing the regions of the breast and muscle tissue from the image;
determining the distance between each of the binarized pixels in a selected corner of the digitized image having a value of “1” and the nearest pixel having a value of “0”, the corner selected being the corner where a patient identification label is likely to be located based on a previous determination of breast side and the standard position of a label in an image;
choosing the maximum distance found in said step of determining the distance; and
comparing the maximum distance to a predetermined threshold value thereby to determine whether the film was inadvertently flipped when scanned and whether there is a label in the corner selected.

12. A method according to claim 11 further including the step of correcting for the flipped image by correctively flipping the image in a direction opposite to the original improper flip.

13. A method according to claim 11 further including the step of correcting for the flipped image by flipping the image and additionally, if required, rotating the image.

14. A method according to claim 10 wherein said step of preparing further includes the step of determining if the image was scanned after being inadvertently rotated.

15. A method according to claim 14 wherein said step of determining further includes the steps of:
providing a binarized digitized image;
removing the regions of the breast and muscle tissue from the image;
removing a previously located label from the image;
determining the size of the largest bright objects in the upper half of the image and the largest object in the lower half of the object; and
comparing the size of the largest bright object in the lower half of the image and of the largest bright object in the upper half of the image against a predetermined value, wherein when the object in the lower half exceeds the predetermined value and the object in the upper half does not, a tag is located in the lower half of the image establishing that the image has been rotated.

16. A method according to claim 15 further including the step of correcting for the inadvertently rotated image by correctively rotating the image.

17. A method for determining if film mammograms have been improperly flipped and rotated prior to feeding the film mammogram into a scanner for providing digitized images, the method including the steps of:
providing a binarized digitized image;
removing the regions of the breast and muscle tissue from the image;
determining the distance between each of the binarized pixels in a selected corner of the digitized image having a value of “1” and the nearest pixel having a value of “0”, the corner selected being the corner where a patient identification label is likely to be located based on a previous determination of breast side and the standard position of a label in an image;
choosing the maximum distance found in said step of determining the distance;
comparing the maximum distance to a predetermined threshold value thereby to determine whether the film was inadvertently flipped when scanned and whether there is a label in the corner selected;
removing the previously located label from the image;
determining the size of the largest bright objects in the upper half of the image and the largest object in the lower half of the object; and
comparing the size of the largest bright object in the lower half of the image and of the largest bright object in the upper half of the image against a predetermined value, wherein when the object in the lower half exceeds the predetermined value and the object in the upper half does not, a tag is located in the lower half of the image establishing that the image has been rotated.

18. A method for scanning film mammograms after a crash of the system performing the scanning, said method including the steps of:
providing a queue file listing examinations submitted but not fully scanned, each line of the listing having a counter prefix (CP);
determining if there are examinations listed in the queue;
determining if the counter prefix is zero for the first line;
removing the first examination from the file if its CP>0 and ejecting all scanned films related to that examination; and
processing remaining queued examinations in the file.

19. A method according to claim 18 wherein said step of providing includes the step of generating a queue file prior to a crash of the system, said step of generating further including the steps of:
entering examination data to the file, setting CP to 0;
scanning the examination films, increasing the CP by one for each film;
determining if the CP for the examination is equal to 4;
removing the examination from the file if CP=4;
checking for a separator film if CP is not 4; and
deleting the examination from the file if a separator file is found during the step of checking.

20. A method according to claim 19 further including the steps of:
deciding if previously queued examinations are to be processed prior to the step of determining if the counter prefix is zero;
processing new examinations if it is decided not to process queued examinations; and
returning to step of determining if the counter prefix is zero if it is decided to process queued examinations.

21. A method for scanning film mammograms and handling scanning failures, said method including the steps of:
determining if an examination is a failed examination using predetermined criteria;
creating a failed file for all examinations that have failed;
ascertaining if there are failed examinations in the failed file;
filling in information for a new examination using information stored in the failed file; and
processing the examination.

22. A method according to claim 21 further including the step of:
entering examination data manually if in the step of ascertaining it has been determined that there are no examinations in the failed file; and
returning to the step of processing.

23. A method according to claim 22 wherein said step of entering data manually is effected even when there is data in the failed file.

24. A method according to claim 21 wherein the failed file is created by a method including the following steps:
scanning a series of film mammograms;
determining if the scanning is a failure;
ejecting all films if the scanning is determined to be a failure; and
adding the failed examination to the failed file.

25. A method according to claim 21 further including the step of:
processing continues normally if the scanning is not deemed a failure in the step of determining if the scanning is a failure.

26. A workstation system for scanning film mammograms, said system including:
a scanner operative to receive and digitize film mammograms from a patient;
processing means for receiving digitized images from said scanner, said processing means being operative to evaluate the digitized images of the film mammograms so as to detect suspicious lesions therein and also operative for storing said digitized images;
wherein said processing means is further operative to analyze, orient and position the digitized images according to a pre-selected presentation scheme irrespective of the order and orientation in which the film mammograms were scanned by the scanner; and
output means in communication with said processing means for outputting said digitized images in the pre-selected presentation scheme.

27. A workstation system according to claim 26 wherein said output means is a printer in communication with said processing means, said printer operative to produce a printout of the digitized images' identifying data and output data relating to the patient, said printout of the images being presented according to the pre-selected presentation scheme.

28. A workstation system according to claim 26 wherein said output means is a display in communication with said processing means, said display operative to display the digitized images according to the pre-selected presentation scheme.

29. A workstation system for scanning film mammograms, said system including:
a scanner operative to receive and digitize radiological film mammograms from a patient;
processing means for receiving digitized images from said scanner, said processing means being operative to evaluate the digitized images of the film mammograms so as to detect suspicious lesions therein and also operative for storing said digitized images;
wherein said processing means is further operative to recognize and indicate failed examinations when entering patient data and scanning film mammograms; and
output means in communication with the processing means for displaying information that an examination has failed.

30. A workstation system as in claim 29 wherein said output means is a display.

31. A workstation system as in claim 29 wherein said output means is a printer.

32. A workstation system for scanning film mammograms, said system including:
a scanner operative to receive and digitize radiological film mammograms from a patient;
processing means for receiving digitized images from said scanner, said processing means being operative to evaluate the digitized images of the film mammograms so as to detect suspicious lesions therein and also operative for storing said digitized images;
wherein said processing means is further operative to allow start up of the system after a system crash using pre-crash entered data obviating the need for reentering such data;
output means in communication with the processing means for displaying information relating to the pre-crash entered data.

33. A workstation system as in claim 32 wherein said output means is a display.

34. A workstation system as in claim 32 wherein said output means is a printer.
